(19) United States
(12) Patent Application Publication
(10) Pub. No.: US 2007/0028503 A1
(43) Pub. Date: Feb. 8, 2007

(54) Duel CounterRotating Whirly Gig Lifter

(75) Inventor: Lawrence Alger Cronce, Stevens Point, WI (US)

Correspondence Address: Mr.Lawrence Alger Cronce, 5139 Hwy 66, Stevens Point, WI, 54481, US

(73) Assignees: NANOSECOND TECHNOLOGIES INCORPORATED, Stevens Point, WI (US); PECIOSECOND TECHNOLOGIES CORPORATION, Stevens Point, WI (US)

(21) Appl. No.: 11/162,234

(22) Filed: Sep. 2, 2005

Related U.S. Application Data
(60) Provisional application No. 60/595,758, filed on Aug. 3, 2005.

(51) Int. Cl. A01K 81/00

(52) U.S. Cl. 43/6

(57) ABSTRACT

This invention of the Duel CounterRotating Whirly Gig System is in fact an system to Produce vertical lift in an system that is on the order of an million times more efficient than the method used by helicopters and is almost totally silent. The system functions by the act of formation of downward low pressure on the top surface via high RPM rotation of an flat polished plated with very low air friction or turbulence. Ideally there would be an flat surface on the bottom to provide the upwards lift, placing the flat surface on the bottom at an angle provides both lift and direction.

The Duel CounterRotating Whirly Gig Lifter is an Ultra efficient system for producing lift.

The design for an individual Whirly Gig lifter is simply an flat round plate on an shaft, which can be surrounded by an air collector diverter on the outer diameter, which collects the air accelerated via rotation and then bends the air flow through an 45 degree arc to point straight down for exhaust. The air collector diverter is stationary and has an opening on the plane of rotation situated to allow air flow into the air collector diverter from the flat rotating plate. Underneath the flat rotating plate is an stationary vacuum plate, the rotating flat plate and the stationary vacuum plate are extremely close together to build up an hard vacuum inbetween and there is an hole in the stationary vacuum plate at the center for the shaft of the rotating plate to pass through. OR the motor can be put at the center on top of the stationary vacuum plate in an indentation to prevent air leakage into the hard vacuum area. There are two Whirly Gigs in an system as each puts an rotational vector on the base from accelerating air in an rotational vector in the opposite direction. The counter rotations of the two whirly gigs cancel each other out, making the base stationary, without any rotational vector.

Now, the function parameters of the Duel CounterRotating Whirly Gig is that air molecules striking the surface are hard accelerated at high RPM towards the outer diameter of the Whirly Gig plates, the net result is that there is virtually Zero downward pressure from the air molecules. This results in the act of formation of incredibly low air pressure on the top surface of the Whirly Gig. And this act of formation of incredibly low air pressure on the top surface creates lift from the base bottom being pressed upwards by air molecules. Also, for most uses, faceted sets of duel Counter rotating whirly gig plates in pairs would be used, whereby each facet for an whirly gig would be on an slight negative angle relative to the others.

What is claimed is:

1. What I claim as my invention is using an high RPM round flat plate on the top surface, to create lift.

2. What I claim as my invention is the use of air collector diverters surrounding the round polished flat whirly gig plates to prevent interaction between whirly gigs and provide additional lift.

3. What I claim as my invention is the use of duel counter rotating whirly gig plates to minimize base rotational vector. Set at an slight angle negative in cases where the air collector diverters are not used to prevent interaction between the duel counter rotating whirly gigs.
